(19) United States
(12) Patent Application Publication
(10) Pub. No.: US 2025/0147160 A1
(43) Pub. Date: May 8, 2025

(54) FITTING METHOD FOR SPONTANEOUS EMISSION NOISE OF LASER RADAR SYSTEM AND OPTICAL FIBER SENSING SYSTEM

(71) Applicant: University of Science and Technology of China, Hefei (CN)

(72) Inventors: Chong Wang, Hefei (CN); Kexin Yang, Hefei (CN); Bin Yang, Hefei (CN); Wei Qiang, Hefei (CN); Xianghui Xue, Hefei (CN); Ruocan Zhao, Hefei (CN)

(73) Assignee: University of Science and Technology of China, Hefei (CN)

(21) Appl. No.: 18/724,578

(22) PCT Filed: Jan. 11, 2022
(86) PCT No.: PCT/CN2022/071204

§ 371 Date: Jun. 26, 2024

(51) Int. Cl. G01S 7/487; G01S 7/481; G01S 7/484

(52) U.S. Cl. CPC G01S 7/487; G01S 7/4811; G01S 7/4818; G01S 7/484

(57) ABSTRACT

Disclosed in the present application is a method for fitting spontaneous emission noise of a lidar system or an optical fiber sensing system. The method includes: providing a trigger collection signal by a signal source; triggering, based on the trigger collection signal, a co-located transceiver module and a distributed transceiver module to perform synchronous detection on a detection target; receiving co-located data and distributed data returned by the detection target; subtracting local noise from the co-located data and the distributed data, respectively; selecting a linear interval to normalize the co-located data; performing subtraction operation on the normalized co-located data and the distributed data to obtain spontaneous emission noise; and fitting the spontaneous emission noise by a function.

### FIELD

The present disclosure relates to the technical field of lidar, and in particular, to a method for fitting spontaneous emission noise of a lidar system and an optical fiber sensing system.

### BACKGROUND

Lidar technology is an active modern optical remote sensing technology and is a hot research field in atmospheric remote sensing. Following a microwave radar, a lidar increases a frequency of a radiation source to an optical frequency, which is four orders of magnitude higher than a millimeter wave, enabling a tiny target, including an aerosol and a molecule in the atmosphere, to be detected. The lidar emits a laser pulse to a target to be detected. After being interacted with the target, a backscattered signal of the target is collected through an optical telescope and input into an optical receiver. After photoelectric detection and data processing, target information is obtained. Using a laser as a carrier, the lidar can carry information using an amplitude, a frequency, a phase, and a polarization state. Therefore, the lidar can not only accurately measure a distance, but also accurately measure a frequency shift, an angle, an attitude, and depolarization. The lidar mainly includes a ranging lidar, a speed lidar, an environmental monitoring lidar, an imaging lidar, a flash lidar, a terrain mapping lidar, a synthetic aperture lidar, etc.

A lidar system can be divided into a laser emission module and a receiver module. In the laser emission module, a linearly polarized light generated by a continuous wave laser is modulated into a pulsed light by an acousto-optic modulator, which is amplified by a fiber amplifier and then is emitted by a telescope. In the fiber amplifier, when an activated particle returns to a ground state from an excited state and the signal is amplified, random incoherent spontaneous emission of the excited particle will be generated. This spontaneous emission can be in any direction and can cause further activated radiation and can be amplified, which is called spontaneous emission noise of the amplifier. A process of the spontaneous emission will extract energy stored in a gain fiber and consume a large number of upper-level inversion particles, resulting in a reduction in a gain extraction rate of the signal. Therefore, the greater the spontaneous emission noise is, the smaller the amplified power of the signal is, that is, the smaller the signal gain is. Meanwhile, a frequency band of the spontaneous emission noise is very wide, which can occupy the entire gain bandwidth and cause the performance of the system to be deteriorated.

Depending on whether optical axes of a lidar optical transmitting system and a receiving system are coaxial, the lidar can be divided into two structures of a distributed transceiver and a co-located transceiver. The structure of the distributed transceiver uses two telescope optical systems for transmitting and receiving, with different optical axes. The receiving telescope only receives an atmospheric echo signal and background noise. For a system of the co-located transceiver, a transmitting system and a receiving system use a same telescope system, with optical axes coincided. Therefore, the receiving system will also be affected by mirror scattering of the transmitting system and spontaneous emission noise of the laser.

### SUMMARY

In view of above, according to the present disclosure, there is provided a method for fitting spontaneous emission noise of a lidar system and an optical fiber sensing system, which can accurately measure the spontaneous emission noise and improve the accuracy of a detection distance and detection data of the lidar system and the optical fiber sensing system.

In order to achieve the above objects, according to the present disclosure, there is provided a technical solution of
a lidar system including:
a signal source, a co-located transceiver module and a distributed transceiver module, wherein the signal source is used to provide a trigger collection signal to simultaneously trigger the co-located transceiver module and the distributed transceiver module to detect a detection target,
wherein the co-located transceiver module has a first telescope for emitting a detection beam and receiving co-located data returned by the detection target, the distributed transceiver module has a second telescope for receiving distributed data returned by the detection target, and spontaneous emission noise is fitted based on the co-located data and the distributed data.

Preferably, in the above lidar system, the first telescope and the second telescope are different,
wherein the first telescope is a monocular telescope for simultaneously emitting the detection light and receiving the co-located data returned by the detection target, and the second telescope is a monocular telescope for receiving the distributed data returned by the detection target.

Preferably, the above lidar system further includes:
a host computer for performing data processing on the co-located data and the distributed data to fit the spontaneous emission noise of the lidar system.

Preferably, in the above lidar system, the co-located transceiver module further includes a laser for emitting the detection beam, an erbium-doped amplifier, a circulator, an optical switch, a filter and a first detector,
wherein a first output end of the signal source is connected to an input end of the laser, an output end of the laser is connected to an input end of the erbium-doped amplifier, an output end of the erbium-doped amplifier is connected to an input end of the circulator, a first output end of the circulator is connected to the first telescope, a second output end of the circulator is connected to an input end of the optical switch, an output end of the optical switch is connected to an input end of the filter, an output end of the filter is connected to a first input end of the first detector, a second output end of the signal source is connected to a second input end of the first detector, and an output end of the first detector is connected to the host computer.

Preferably, in the above lidar system, the distributed transceiver module further includes a laser, an erbium-doped amplifier, a circulator, the first telescope and a second detector,
wherein a first output end of the signal source is connected to an input end of the laser, an output end of the laser is connected to an input end of the erbium-doped amplifier, an output end of the erbium-doped amplifier is connected to an input end of the circulator, a first output end of the circulator is connected to the first telescope, a third output end of the signal source is connected to a first input end of the second detector, an output end of the second telescope is connected to a second input end of the second detector, and an output end of the second detector is connected to the host computer.

According to the present disclosure, there is further provided an optical fiber sensing system including:
a signal source, a laser, a circulator, an optical fiber disk and an optical switch, wherein the signal source is used to provide a trigger collection signal to trigger the laser to emit a detection beam to detect a detection target,
wherein the optical switch is used to control a switch of the circulator, and the optical switch has a first state in which the optical switch is turned on, the detection beam is emitted through a first output end of the circulator and then is output by the optical fiber disk, and co-located data is returned by the detection target based on the detection beam; and a second state in which the optical switch cuts off the first output end of the circulator, the detection beam enters the optical switch through a second output end of the circulator, and distributed data is received.

Preferably, the above optical fiber sensing system further includes:
an erbium-doped amplifier, a filter, a detector and a host computer, wherein the host computer is used to perform data processing on the co-located data and the distributed data to fit spontaneous emission noise of the optical fiber sensing system,
wherein a first output end of the signal source is connected to an input end of the laser, an output end of the laser is connected to an input end of the erbium-doped amplifier, an output end of the erbium-doped amplifier is connected to an input end of the circulator, a first output end of the circulator is connected to an input end of the optical fiber disk, a second output end of the circulator is connected to an input end of the optical switch, an output end of the optical switch is connected to an input end of the filter, an output end of the filter is connected to a first input end of the detector, a second output end of the signal source is connected to a second input end of the detector, and an output end of the detector is connected to the host computer.

According to the present disclosure, there is further provided a method for fitting spontaneous emission noise, which is applied to a lidar system or an optical fiber sensing system, wherein the lidar system is the above-mentioned lidar system, the optical fiber sensing system is the above-mentioned optical fiber sensing system, and the method includes:
providing a trigger collection signal by a signal source;
triggering, based on the trigger collection signal, a co-located transceiver module and a distributed transceiver module to perform synchronous detection on a detection target;
receiving co-located data and distributed data returned by the detection target;
subtracting local noise from the co-located data and the distributed data, respectively;
selecting a linear interval to normalize the co-located data;
performing subtraction operation on the normalized co-located data and the distributed data to obtain spontaneous emission noise; and
fitting the spontaneous emission noise by a function.

It can be seen from the above that, in a method for fitting spontaneous emission noise of a lidar system and an optical fiber sensing system provided by the technical solution of the present disclosure, by using a controlled variable method and comparing co-located data and distributed data, spontaneous emission noise is obtained by means of fitting, which is beneficial for evaluating the performance of a laser. After the spontaneous emission noise is obtained by means of measurement, a filter having an appropriate bandwidth and a follow-up signal noise processing algorithm are selected, such that the effect of the spontaneous emission noise on an echo signal can be eliminated, and the accuracy of a detection distance and detection data of the lidar system and the optical fiber sensing system can be improved. In addition, after the spontaneous emission noise is obtained by means of fitting, a calibrated monocular telescope can be used alone to implement detection by means of a single-photon radar free of the interference of the spontaneous emission noise.

### BRIEF DESCRIPTION OF THE DRAWINGS

In order to explain the embodiments of the present disclosure or the technical solutions in the prior art more clearly, the drawings needed to be used in the description of the embodiments or the prior art will be briefly introduced below. Obviously, the drawings in the following description are only an embodiment of the present disclosure. For those of ordinary skill in the art, other drawings can be obtained based on the provided drawings without exerting creative efforts.

The structures, proportions, sizes, etc. shown in the drawings of this specification are only used to coordinate with the content disclosed in the specification and are for the understanding and reading of people familiar with this technology. They are not used to limit the conditions for the implementation of the present disclosure, and therefore have no technical substantive significance. Any structural modifications, changes in proportions or adjustments in size shall still fall within the scope of the technology disclosed in the present disclosure as long as it does not affect the effect that the present disclosure can produce and the purpose that it can achieve.

FIG. 1 is a schematic structural diagram of a lidar system provided by an embodiment of the present disclosure;

FIG. 2 is a flow chart of a method for fitting spontaneous emission noise of a lidar system provided by an embodiment of the present disclosure;

FIG. 3 is a comparison chart of the number of photons received by a distributed transceiver module and a co-located transceiver module when spontaneous emission noise is not corrected;

FIG. 4 is a comparison chart of the number of photons received by a distributed transceiver module and a co-located transceiver module when spontaneous emission noise has been corrected;

FIG. 5 shows a correlation coefficient between a co-located end and a distributed end after ASE correction; and

FIG. 6 is a schematic structural diagram of an optical fiber sensing system provided by an embodiment of the present disclosure.

### DETAILED DESCRIPTION OF EMBODIMENTS

The embodiments in the present disclosure will be clearly and completely described below with reference to the accompanying drawings in the embodiments of the present disclosure. Obviously, the described embodiments are only some of the embodiments of the present disclosure, rather than all of the embodiments. Based on the embodiments in the present disclosure, all other embodiments obtained by those of ordinary skill in the art without creative efforts fall within the scope of protection of the present disclosure.

In order to make the above objects, features and advantages of the present disclosure more obvious and understandable, the present disclosure will be described in further detail below in conjunction with the accompanying drawings and specific embodiments.

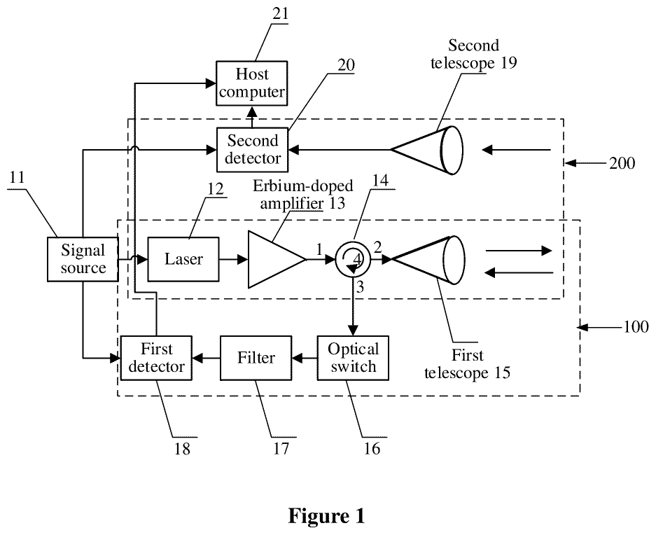

Reference is made to FIG. 1, which is a schematic structural diagram of a lidar system provided by an embodiment of the present disclosure. Herein, a working wavelength of the lidar system is 1548 nm.

As shown in FIG. 1, the lidar system includes a signal source 11, a co-location transceiver module 100 and a distributed transceiver module 200. The signal source 11 is used to provide a trigger collection signal to simultaneously trigger the co-location transceiver module 100 and the distributed transceiver module 200 to detect a detection target.

Herein, the co-located transceiver module 100 has a first telescope 15 for emitting a detection beam and receiving co-located data returned by the detection target. The distributed transceiver module 200 has a second telescope 19 for receiving distributed data returned by the detection target. Based on the co-located data and the distributed data, spontaneous emission noise is fitted.

In the embodiment of the present disclosure, the first telescope 15 and the second telescope 19 are different.

The first telescope 15 is a monocular telescope for simultaneously emitting the detection light and receiving the co-located data returned by the detection target. The second telescope 19 is a monocular telescope for receiving the distributed data returned by the detection target.

It should be noted that the second telescope 19 is only used during factory calibration. After the spontaneous emission noise (ASE noise) is obtained by means of fitting, the calibrated monocular telescope can be used alone to implement detection by means of a single-photon radar free of the interference of the ASE noise.

Based on the lidar system shown in FIG. 1, it further includes a host computer 21 for performing data processing on the co-located data and the distributed data to fit the spontaneous emission noise of the lidar system.

As shown in FIG. 1, both the co-located transceiver module 100 and the distributed transceiver module 200 have a laser 12, an erbium-doped amplifier 13, a circulator 14, an optical switch 16, a filter 17, a first detector 18, and the first telescope 15. The laser 12 is used to emit the detection beam.

Herein, a first output end of the signal source 11 is connected to an input end of the laser 12, an output end of the laser 12 is connected to an input end of the erbium-doped amplifier 13, an output end of the erbium-doped amplifier 13 is connected to an input end 1 of the circulator 14, a first output end 2 of the circulator 14 is connected to the first telescope 15, a second output end 3 of the circulator 14 is connected to an input end of the optical switch 16, an output end of the optical switch 16 is connected to an input end of the filter 17, an output end of the filter 17 is connected to a first input end of the first detector 18, a second output end of the signal source 11 is connected to a second input end of the first detector 18, and an output end of the first detector 18 is connected to the host computer 21.

Specifically, when the signal source 11 provides a trigger collection signal, the laser 12 is triggered to emit the detection beam. After being amplified by the erbium-doped amplifier 13, the detection beam passes through the first output end 2 of the circulator 14 and the first telescope 15 to emit. The detection target returns co-location data based on the detection beam, and the first telescope 15 receives and sends the co-location data to the circulator 14. The co-location data enters the optical switch 16 through the second output end 3 of the circulator 14 to eliminate specular reflection. Then, the co-location data passes through the filter 17 and enters the first detector 18, and is transmitted to the host computer 21 through the first detector 18.

Herein, the first detector 18 may be a single photon detector.

As shown in FIG. 1, the distributed transceiver module 200 further includes a laser 12, an erbium-doped amplifier 13, a circulator 14, the first telescope 15, and a second detector 20 which can be a single photon detector.

Herein, a first output end of the signal source 11 is connected to an input end of the laser 12, an output end of the laser 12 is connected to an input end of the erbium-doped amplifier 13, an output end of the erbium-doped amplifier 13 is connected to an input end 1 of the circulator 14, a first output end 2 of the circulator 14 is connected to the first telescope 15, a third output end of the signal source 11 is connected to a first input end of the second detector 20, an output end of the second telescope 19 is connected to a second input end of the second detector 20, and an output end of the second detector 20 is connected to the host computer 21.

Specifically, when the signal source 11 provides a trigger collection signal, the laser 12 is triggered to emit the detection beam. After being amplified by the erbium-doped amplifier 13, the detection beam passes through the first output end 2 of the circulator 14 and the first telescope 15 to emit. The detection target returns distributed data based on the detection beam, and the second telescope 19 receives and sends the distributed data to the second detector 20, through which the distributed data is transmitted to the host computer 21. The host computer 21 performs data processing based on the co-located data and the distributed data to fit the spontaneous emission noise of the lidar system.

It can be seen from the above that, in the lidar system provided by the technical solution of the present disclosure, by using a controlled variable method and comparing the co-located data and the distributed data, spontaneous emission noise is obtained by means of fitting, which is beneficial for evaluating the performance of the laser. After the spontaneous emission noise is obtained by means of measurement, a filter having an appropriate bandwidth and a follow-up signal noise processing algorithm are selected, such that the effect of spontaneous emission noise on an echo signal can be eliminated, and the accuracy of a detection distance and detection data of the lidar system and the optical fiber sensing system can be improved. In addition, after the spontaneous emission noise is obtained by means of fitting, a calibrated monocular telescope can be used alone to implement detection by means of a single-photon radar free of the interference of the spontaneous emission noise.

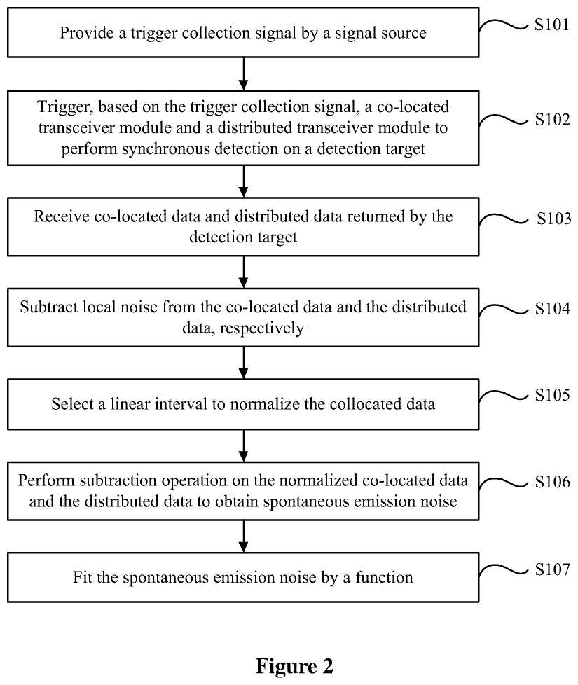

Based on the above lidar system, according to another embodiment of the present disclosure, there is further provided a method for fitting spontaneous emission noise of a lidar system, as shown in FIG. 2. FIG. 2 shows a flow chart of a method for fitting spontaneous emission noise of a lidar system provided by an embodiment of the present disclosure. The method includes the following steps.
Step S101: provide a trigger collection signal by a signal source.
Step S102: trigger, based on the trigger collection signal, a co-located transceiver module and a distributed transceiver module to perform synchronous detection on a detection target.
Step S103: receive co-located data and distributed data returned by the detection target.
Step S104: subtract local noise from the co-located data and the distributed data, respectively.
Step S105: select a linear interval to normalize the co-located data.
Step S106: perform subtraction operation on the normalized co-located data and the distributed data to obtain spontaneous emission noise.
Step S107: fit the spontaneous emission noise by a function.

Specifically, the signal source first provides the trigger collection signal to trigger the co-located transceiver module and the distributed transceiver module to perform synchronous detection on the detection target. Then, the local noise is subtracted from the received co-located data and distributed data, respectively, to eliminate the influence of background noise.

The form of the number of photons of the lidar system ignoring the local noise is:

$$N ( R ) = E {η}_{0} \frac{{η}_{q}}{hv} \frac{A}{{R}^{2}} O ( R ) \frac{c Δ t}{2} β ( R ) exp [ - 2 {\int }_{0}^{r} σ ( {R}^{r} ) {dR}^{r} ]$$

where N(R) represents the number of photons in an echo signal returned at distance R, E represents the number of photons in the emitting pulse, η₀ represents the optical receiving efficiency of the entire system, η_{q} is the quantum efficiency of the detector, h is Planck's constant, v is the frequency of the laser, A is the effective area of the second telescope, O(R) is the collective overlap factor of the spot receiving field of view, c is the speed of light, Δt is the pulse width, and β and σ are the backscattering coefficient and extinction coefficient of the atmosphere, respectively.

During the calculation process, using the logarithmic distance correction signal S(R) will greatly increase the calculation speed:

$$S ( R ) = In [ {R}^{2} N ( R ) ]$$

If a reference point is selected, which is distanced from the laser emission position by R₀, then the above can be written as:

$$S - {S}_{0} = In \frac{β}{{β}_{0}} - 2 {\int }_{r 0}^{r} σ {dr}^{r}$$

where S₀ and β₀ are the distance correction signal of the reference point position and the total idol scattering coefficient in the atmosphere, respectively. Then, differentiate the above equation with respect to distance to get:

$$\frac{dS}{dR} = \frac{1}{β} \frac{d β}{dR} - 2 σ$$

When the atmosphere of the lidar system is relatively uniform, it can be considered that the backscattering coefficient does not change with distance. Thus, the first term on the right side of the above equation is eliminated and it becomes:

$$\frac{d \{ In [ {R}^{2} N ( R ) ] \}}{dR} = - 2 {σ}_{hom}$$

The subscript of σₕₒₘ represents the atmospheric extinction coefficient calculated at this time assuming a uniform atmosphere. Therefore, the interval in which echo signals received by the co-located transceiver module and the distributed transceiver module have the same slope is intercepted to ensure that the subsequently processed co-located data and distributed data are obtained by detecting the same section of uniform atmosphere.

In order to eliminate the influence of the optical switches and filters of the co-located transceiver module and the inconsistent lens barrel sizes of the co-located transceiver module and the distributed transceiver module, the data of the co-located transceiver module is normalized:

$${log}_{10} ( ( {N}_{D} ( R ) - n ) {R}^{2} ) - {log}_{10} ( ( {N}_{s} ( R ) - n ) {R}^{2} ) = C$$

where N_{D}(R) and N_{S}(R) are the number of photons received by the co-located transceiver module and the distributed transceiver module, respectively, n is the local noise, and C is a constant.

From the above formula, the normalized co-located data Nₛₙ(R) can be obtained as:

$${N}_{sn} ( R ) = ( {N}_{s} ( R ) - n ) \times 1 {0}^{c}$$

The spontaneous emission noise N_{ASE}(R) of the laser can be obtained by subtracting the distributed data from the normalized co-located data:

$${N}_{ASE} ( R ) = {N}_{sn} ( R ) - ( {N}_{D} ( R ) - n )$$

Finally, the spontaneous emission noise is fitted by a function of the following form:

$${f}_{AES} ( R ) = {a}_{0} + {a}_{1} R + {a}_{2} {R}^{2} + {a}_{3} {e}^{{a}_{4} R}$$

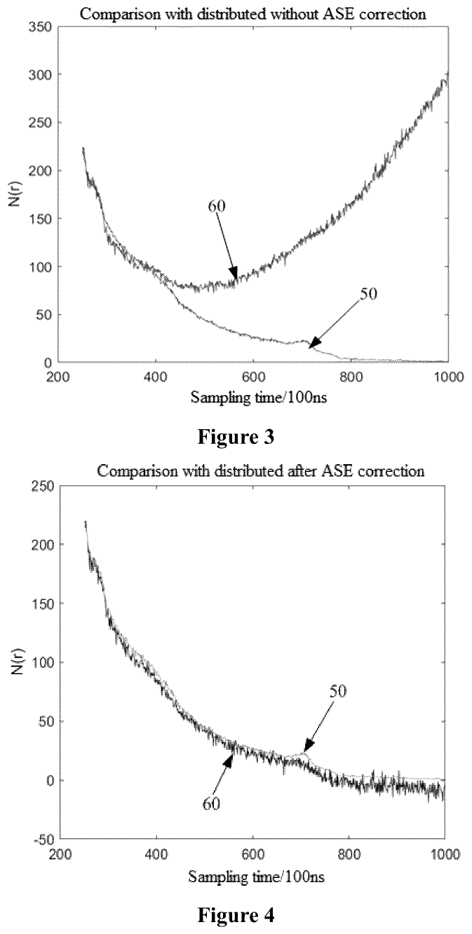

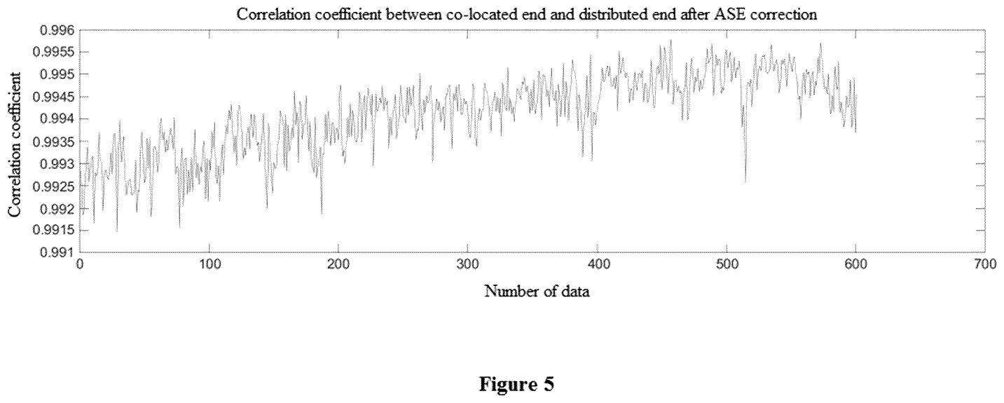

Reference is made to FIGS. 3 to 5. FIG. 3 shows the comparison of the number of photons received by a distributed transceiver module and a co-located transceiver module when spontaneous emission noise is not corrected, FIG. 4 is a comparison chart of the number of photons received by the distributed transceiver module and the co-located transceiver module when the spontaneous emission noise has been corrected, and FIG. 5 shows a correlation coefficient between a co-located end and a distributed end after ASE correction.

In the patterns shown in FIGS. 3 to 5, 50 represents the curve of the number of photons received by the distributed transceiver module, and 60 represents the curve of the number of photons received by the co-located transceiver module. It can be seen that, compared with that before correction, the data of the distributed transceiver module and the co-located transceiver module after correction reaches a high degree of correlation, indicating that effective fitting of the spontaneous emission noise is achieved according to the present disclosure.

It can be seen from the above that, in a method for fitting spontaneous emission noise of a lidar system provided by the technical solution of the present disclosure, by using a controlled variable method and comparing co-located data and distributed data, spontaneous emission noise is obtained by means of fitting, which is beneficial for evaluating the performance of a laser. After the spontaneous emission noise is obtained by means of measurement, a filter having an appropriate bandwidth and a follow-up signal noise processing algorithm are selected, such that the effect of the spontaneous emission noise on an echo signal can be eliminated, and the accuracy of a detection distance and detection data of the lidar system and the optical fiber sensing system can be improved. In addition, after the spontaneous emission noise is obtained by means of fitting, a calibrated monocular telescope can be used alone to implement detection by means of a single-photon radar free of the interference of the spontaneous emission noise.

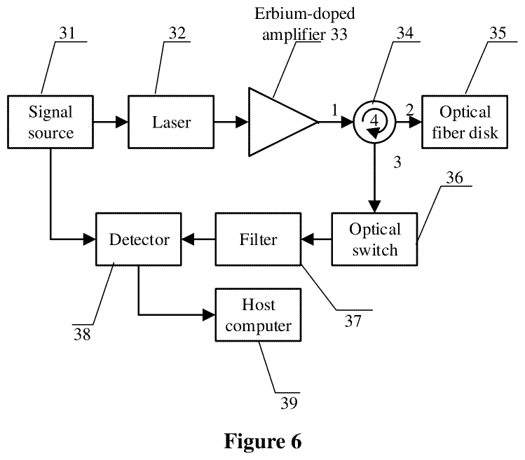

Based on the above embodiments, according to another embodiment of the present disclosure, there is further provided an optical fiber sensing system, as shown in FIG. 6. FIG. 6 is a schematic structural diagram of an optical fiber sensor provided by an embodiment of the present disclosure. The optical fiber sensing system includes a signal source 31, a laser 32, a circulator 34, an optical fiber disk 35, and an optical switch 36. The signal source 31 is used to provide a trigger collection signal to trigger the laser 32 to emit a detection beam to detect a detection target.

Herein, the optical switch 36 is used to control a switch of the circulator 34, and the optical switch 36 has a first state and a second state. In the first state, the optical switch 36 is turned on, the detection light beam is emitted through a first output end 2 of the circulator 34 and then is output by the optical fiber disk 35, and co-located data is returned by the detection target based on the detection beam. In the second state, the optical switch 36 cuts off the first output end of the circulator 34, the detection beam enters the optical switch 36 through a second output end 3 of the circulator 34, and distributed data is received.

Based on the optical fiber sensing system shown in FIG. 6, it further includes an erbium-doped amplifier 33, a filter 37, a detector 38, and a host computer 39. The host computer 39 is used to perform data processing on the co-located data and the distributed data to fit spontaneous emission noise of the optical fiber sensing system.

Herein, a first output end of the signal source 31 is connected to an input end of the laser 32, an output end of the laser 32 is connected to an input end of the erbium-doped amplifier 33, an output end of the erbium-doped amplifier 33 is connected to an input end 1 of the circulator 34, a first output end 2 of the circulator 34 is connected to an input end of the optical fiber disk 35, a second output end 3 of the circulator 34 is connected to an input end of the optical switch 36, an output end of the optical switch 36 is connected to an input end of the filter 37, an output end of the filter 37 is connected to a first input end of the detector 38, a second output end of the signal source 31 is connected to a second input end of the detector 38, and an output end of the detector 38 is connected to the host computer 39.

Specifically, when the optical switch 36 is in the first state, the optical switch 36 is turned on, and the detection beam emitted by the laser 32 is amplified by the erbium-doped amplifier 33 and is emitted through the first output end 2 of the circulator 34. Then, the detection beam is transmitted by the optical fiber disk 35. The co-located data is returned by the detection target based on the detection beam. The optical fiber disk 35 receives and sends the co-located data to the circulator 34. The co-located data enters the optical switch 36 through the second output end 3 of the circulator 34 to eliminate specular reflection, and then enters the detector 38 through the filter 37. The co-located data is transmitted to the host computer 39 through the detector 38. In the second state, the light switch 36 cuts off the first output end 2 of the circulator 34. After the detection beam emitted by the laser 32 is amplified by the erbium-doped amplifier 33, it passes through the second output end 3 of the circulator 34 and enters the optical switch 36 to obtain the distributed data. Then, the distributed data passes through the filter 37 and enters the detector 38, and is transmitted to the host computer 39 through the detector 38.

In the optical fiber sensing system, the acquisition of the co-located data and the distributed data is achieved through the control of the circulator 34 by the optical switch 36. When collecting the co-located data, the optical switch 36 is turned on. After the detection beam is emitted through the first output end 2 of the circulator 34, it is transmitted by the optical fiber disk 35, and reflected into the second output end 3 of the circulator 34. Then, it enters the filter 37 through the optical switch 36. When collecting the distributed data, the optical switch 36 cuts off the input of the first output end 2 of the circulator 34, and thus what is received at the second output end 3 of the circulator 34 is the distributed data without the spontaneous emission noise.

It can be seen from the above that, in an optical fiber sensing system provided by the technical solution of the present disclosure, by using a controlled variable method and comparing co-located data and distributed data, spontaneous emission noise is obtained by means of fitting, which is beneficial for evaluating the performance of a laser. After the spontaneous emission noise is obtained by means of measurement, a filter having an appropriate bandwidth and a follow-up signal noise processing algorithm are selected, such that the effect of the spontaneous emission noise on an echo signal can be eliminated, and the accuracy of a detection distance and detection data of the lidar system and the optical fiber sensing system can be improved. In addition, after the spontaneous emission noise is obtained by means of fitting, a calibrated monocular telescope can be used alone to implement detection by means of a single-photon radar free of the interference of the spontaneous emission noise.

Based on the above optical fiber sensing system, according to another embodiment of the present disclosure, there is further provided a method for fitting spontaneous emission noise of an optical fiber sensing system, as shown in FIG. 2. The method includes the following steps.
Step S101: provide a trigger collection signal by a signal source.
Step S102: trigger, based on the trigger collection signal, a co-located transceiver module and a distributed transceiver module to perform synchronous detection on a detection target.
Step S103: receive co-located data and distributed data returned by the detection target.
Step S104: subtract local noise from the co-located data and the distributed data, respectively.
Step S105: select a linear interval to normalize the co-located data.
Step S106: perform subtraction operation on the normalized co-located data and the distributed data to obtain spontaneous emission noise.
Step S107: fit the spontaneous emission noise by a function.

It should be noted that the method for fitting spontaneous emission noise adopted by the optical fiber sensing system and the lidar system is the same. Reference can be made to the method for fitting spontaneous emission noise of the lidar system in the above embodiment, which will not be repeated herein.

It can be seen from the above that, in the method for fitting spontaneous emission noise of an optical fiber sensing system provided by the technical solution of the present disclosure, by using a controlled variable method and comparing co-located data and distributed data, spontaneous emission noise is obtained by means of fitting, which is beneficial for evaluating the performance of a laser. After the spontaneous emission noise is obtained by means of measurement, a filter having an appropriate bandwidth and a follow-up signal noise processing algorithm are selected, such that the effect of the spontaneous emission noise on an echo signal can be eliminated, and the accuracy of a detection distance and detection data of the lidar system and the optical fiber sensing system can be improved. In addition, after the spontaneous emission noise is obtained by means of fitting, a calibrated monocular telescope can be used alone to implement detection by means of a single-photon radar free of the interference of the spontaneous emission noise.

Each embodiment in this specification is described in a manner of progressive, parallel, or combination of progressive and parallel. Each embodiment focuses on its differences from other embodiments. The same and similar parts among the various embodiments can be referred to each other.

It should be noted that, in this specification, relational terms such as first and second are only used to distinguish one entity or operation from another entity or operation, and do not necessarily require or imply any actual relationship or sequence between these entities or operations. Furthermore, the terms “comprises,” “includes,” or any other variation thereof are intended to cover a non-exclusive inclusion, such that an article or device including a list of elements includes not only those elements, but also other elements not expressly listed, or it also includes elements inherent to the article or device. Without further limitation, an element defined by the statement “comprises a . . . ” does not exclude the presence of other identical elements in an article or device that includes the above-mentioned element.

The above description of the disclosed embodiments enables those skilled in the art to implement or use the present disclosure. Various modifications to these embodiments will be readily apparent to those skilled in the art, and the generic principles defined herein may be practiced in other embodiments without departing from the spirit or scope of the present disclosure. Therefore, the present disclosure is not to be limited to the embodiments shown herein but is to be accorded the widest scope consistent with the principles and novel features disclosed herein.

1. A lidar system comprising:
a signal source, a co-located transceiver module and a distributed transceiver module, wherein the signal source is used to provide a trigger collection signal to simultaneously trigger the co-located transceiver module and the distributed transceiver module to detect a detection target,
wherein the co-located transceiver module has a first telescope for emitting a detection beam and receiving co-located data returned by the detection target, the distributed transceiver module has a second telescope for receiving distributed data returned by the detection target, and spontaneous emission noise is fitted based on the co-located data and the distributed data.

2. The lidar system according to claim 1, wherein the first telescope and the second telescope are different, wherein the first telescope is a monocular telescope for simultaneously emitting the detection beam and receiving the co-located data returned by the detection target, and the second telescope is a monocular telescope for receiving the distributed data returned by the detection target.

3. The lidar system according to claim 1, further comprising:
a host computer for performing data processing on the co-located data and the distributed data to fit the spontaneous emission noise of the lidar system.

4. The lidar system according to claim 1, wherein the co-located transceiver module further comprises a laser for emitting the detection beam, an erbium-doped amplifier, a circulator, an optical switch, a filter, and a first detector,
wherein a first output end of the signal source is connected to an input end of the laser, an output end of the laser is connected to an input end of the erbium-doped amplifier, an output end of the erbium-doped amplifier is connected to an input end of the circulator, a first output end of the circulator is connected to the first telescope, a second output end of the circulator is connected to an input end of the optical switch, an output end of the optical switch is connected to an input end of the filter, an output end of the filter is connected to a first input end of the first detector, a second output end of the signal source is connected to a second input end of the first detector, and an output end of the first detector is connected to the host computer.

5. The lidar system according to claim 1, wherein the distributed transceiver module further comprises a laser, an erbium-doped amplifier, a circulator, the first telescope, and a second detector,
wherein a first output end of the signal source is connected to an input end of the laser, an output end of the laser is connected to an input end of the erbium-doped amplifier, an output end of the erbium-doped amplifier is connected to an input end of the circulator, a first output end of the circulator is connected to the first telescope, a third output end of the signal source is connected to a first input end of the second detector, an output end of the second telescope is connected to a second input end of the second detector, and an output end of the second detector is connected to the host computer.

6. An optical fiber sensing system comprising:
a signal source, a laser, a circulator, an optical fiber disk, and an optical switch, wherein the signal source is used to provide a trigger collection signal to trigger the laser to emit a detection beam to detect a detection target,
wherein the optical switch is used to control a switch of the circulator, and the optical switch has a first state in which the optical switch is turned on, the detection beam is emitted through a first output end of the circulator, and then is output by the optical fiber disk, and co-located data is returned by the detection target based on the detection beam; and a second state in which the optical switch cuts off the first output end of the circulator, the detection beam enters the optical switch through a second output end of the circulator, and distributed data is received.

7. The optical fiber sensing system according to claim 6, further comprising:
an erbium-doped amplifier, a filter, a detector, and a host computer, wherein the host computer is used to perform data processing on the co-located data and the distributed data to fit spontaneous emission noise of the optical fiber sensing system,
wherein a first output end of the signal source is connected to an input end of the laser, an output end of the laser is connected to an input end of the erbium-doped amplifier, an output end of the erbium-doped amplifier is connected to an input end of the circulator, a first output end of the circulator is connected to an input end of the optical fiber disk, a second output end of the circulator is connected to an input end of the optical switch, an output end of the optical switch is connected to an input end of the filter, an output end of the filter is connected to a first input end of the detector, a second output end of the signal source is connected to a second input end of the detector, and an output end of the detector is connected to the host computer.

8. A method for fitting spontaneous emission noise, which is applied to a lidar system or an optical fiber sensing system,
wherein the lidar system comprises a signal source, a co-located transceiver module and a distributed transceiver module, the signal source is used to provide a trigger collection signal to simultaneously trigger the co-located transceiver module and the distributed transceiver module to detect a detection target, the co-located transceiver module has a first telescope for emitting a detection beam and receiving co-located data returned by the detection target, the distributed transceiver module has a second telescope for receiving distributed data returned by the detection target, and spontaneous emission noise is fitted based on the co-located data and the distributed data;
wherein the optical fiber sensing system comprises a signal source, a laser, a circulator, an optical fiber disk, and an optical switch, the signal source is used to provide a trigger collection signal to trigger the laser to emit a detection beam to detect a detection target, the optical switch is used to control a switch of the circulator, the optical switch has a first state and a second state: in the first state, the optical switch is turned on, the detection beam is emitted through a first output end of the circulator, and then is output by the optical fiber disk, and co-located data is returned by the detection target based on the detection beam; and in the second state, the optical switch cuts off the first output end of the circulator, the detection beam enters the optical switch through a second output end of the circulator, and distributed data is received;
wherein the method comprises:
providing a trigger collection signal by a signal source;
triggering, based on the trigger collection signal, a co-located transceiver module and a distributed transceiver module to perform synchronous detection on a detection target;
receiving co-located data and distributed data returned by the detection target;
subtracting local noise from the co-located data and the distributed data, respectively;
selecting a linear interval to normalize the co-located data;
performing subtraction operation on the normalized co-located data and the distributed data to obtain spontaneous emission noise; and
fitting the spontaneous emission noise by a function.
